(19) United States
(12) Patent Application Publication
(10) Pub. No.: US 2024/0185007 A1
(43) Pub. Date: Jun. 6, 2024

(54) Scalable, Event-based Sensing Using Wireless Sensor Elements Embedded in Flexible Elastomer

(71) Applicant: THE JOHNS HOPKINS UNIVERSITY, Baltimore, MD (US)

(72) Inventor: Ariel Slepyan, Hewlett, NY (US)

(21) Appl. No.: 18/553,717

(22) PCT Filed: Mar. 31, 2022
(86) PCT No.: PCT/US2022/022869

§ 371 Date: Oct. 2, 2023

Related U.S. Application Data
(60) Provisional application No. 63/168,485, filed on Mar. 31, 2021.

(51) Int. Cl. G06K 7/10; G01L 1/26

(52) U.S. Cl. CPC G06K 7/10297; G01L 1/26

(57) ABSTRACT

A design for large scale, event-based sensing uses a wireless communications protocol. This technology allows for event-based, analog sensing of any modality. The technology of the present invention includes modular, wireless sensors. These sensors can be easily mixed and matched over a large area. The present invention can be applied to e-skins, and other applications that require many sensors over a large area. Each sensing ‘pixel’ of the skin is linked to a unique wireless tag. ID number such as an RFID. All of the sensors can then be read by one wireless reader, and by realizing the ID of a tag, the exact location is determined. Therefore, this translates to an event-based sensor as the reader is constantly listening for a responding tag, but only tags with pressure events respond.

### CROSS REFERENCE TO RELATED APPLICATIONS

This application claims the benefit of U.S. Provisional Patent Application No. 63/168,485 filed on Mar. 31, 2021, which is incorporated by reference, herein, in its entirety.

### FIELD OF THE INVENTION

The present invention relates generally to sensors. More particularly the present invention relates to scalable, event-based sensing using wireless sensor elements embedded in a flexible elastomer.

### BACKGROUND OF THE INVENTION

The skin is the human body's largest organ, and arguably one of the most complex. For humans to simultaneously obtain tactile information across the entire area of the skin with fast reaction time, mechanoreceptors in the skin employ event-based encoding through neural spiking. This is done through the use of different tactile afferents and upstream information processing. For example, the Meissner corpuscle (rapidly adapting type I mechanoreceptor) and the Pacinian corpuscle (rapidly adapting type II mechanoreceptor) generate spikes only during transition events, and not for static values. Replicating this information processing scheme can be beneficial for fabricating e-skins that cover large areas like the human skin and that can obtain tactile information across the entire e-skin.

However, research in tactile sensors has been very one-directional and has lagged the development of a large-scale e-skin with tactile sensing capabilities across the entire area of the skin. The state-of-the-art includes grid-based, tactile, sensing arrays made from piezoresistive and piezoelectric materials, or organic photo diodes for optical based measurements—with most research focusing on increasing the tactile array size, developing new sensing materials, or improving the taxel density or temporal resolution. Additionally, to obtain comprehensive tactile information, constant sampling of the array elements is performed to read pressure inputs across the entire grid. This leads to slow acquisition times when sensing arrays become very large and trigger redundant data acquisition if pressure events are not occurring. Therefore, progress towards a truly scalable and functional e-skin is limited.

The human skin has a high-density of mechanoreceptors, high temporal resolution, high flexibility, and large area coverage. Replicating these criteria is highly desirable for designing an e-skin. Moreover, for prosthetic applications, compact design and low cost are also important criteria to consider in design. Limited progress has been made towards combining high-density taxels with a high temporal resolution over a large area, because of the inherent trade-off between temporal and spatial resolution. This is mitigated through the use of asynchronous coding with a constant latency of 1 millisecond. However, this solution suffers in compact design, and contains a very large processing circuit board off-the sensing grid. A large processing circuit board makes the design impractical for prosthetic applications or in other applications where portability is critical.

Some progress has been made towards large area coverage, compact design, flexibility, and low cost; however, where progress has been made, this has led to a compromise on high-density taxels with high temporal resolution. The scalable tactile glove (STAG) represented the first time that researchers developed a large-scale tactile sensing hand with 548 taxels. Taxels have a 2.5 mm spacing and the hand has a sampling rate of 7 Hz. This low sampling rate is a result of the high number of taxels and the need for sequential reading of pressure from all of these taxels, pointing to an inherent tradeoff between spatial and temporal resolutions.

It would therefore be advantageous to provide an improved design for e-skin.

### SUMMARY OF THE INVENTION

In accordance with an embodiment, the present invention provides a device including a modular, wireless sensor. The modular wireless sensor has an identification tag and is configured to transmit the identification tag in response to a sensor event. A wireless reader receives input from the modular wireless sensor. The wireless reader identifies the modular wireless sensor experiencing the sensor event using the identification tag,

In accordance with an aspect of the present invention the modular, wireless sensor takes the form of a radio frequency identification (RFID) sensor. The modular, wireless sensor can alternately take the form of an NFC sensor. The sensor event is pressure applied to the modular, wireless sensor. The RFID sensor includes an RFID chip and an RFID antenna. The RFID chip and the RFID antenna are separated such that a pressure event is needed to reconnect the RFID chip to the RFID antenna to allow the RIFD sensor to transmit the identification tag.

In accordance with another aspect of the present invention, the modular, wireless sensor is configured to use tuple frequency encoding, such that the wireless sensor communicates a combination of two or more frequencies. The wireless sensor does not require the integration of oscillators, microcontrollers, or other electronics into each sensing pixel.

In accordance with another aspect of the present invention includes a modular, wireless sensor. The modular wireless sensor is configured to use tuple frequency encoding, such that the wireless sensor communicates a combination of two or more frequencies. The device also includes a wireless reader for receiving input from the modular wireless sensor. The wireless reader identifies the frequencies transmitted by the wireless sensor.

In accordance with yet another aspect of the present invention, the modular, wireless sensor can take the form of a radio frequency identification (RFID) sensor, a near field communication (NFC) sensor, a sensor array, and/or an application-specific integrated circuit (ASIC) chip. The sensor event takes the form of pressure applied to the modular, wireless sensor. The RFID sensor can include an RFID chip and an RFID antenna. The sensor array can include different types of sensors.

### BRIEF DESCRIPTION OF THE FIGURES

FIGS. 1A-1C illustrate various actuation methods for transforming an RFID tag into a pressure-based event sensor.

FIG. 2 illustrates an FEMM simulation showing an axisymmetrical model of the non-uniform magnetic field generated by a loop of 26AWG copper wire with 2 turns (modelled after a commercial 13.56 MHz RFID reader antenna).

FIG. 3 illustrates a schematic diagram showing the process of removing the RFID chip and RFID antenna from a commercial RFID tag.

FIGS. 4A and 4B illustrate schematic diagrams showing the setup of the 1-taxel pressure sensor.

FIGS. 5A and 5B illustrate perspective views of the different Ecoflex™ layers used in the building of the full-hand RFID tactile sensor and the 2×2 RFID tactile sensor.

FIG. 6 illustrates a schematic diagram showing the working principle of the RFID relay antenna.

FIGS. 7A-7D illustrate views showing the components of the NFC-based sensing hand.

FIG. 8 illustrates a graphical view of a characterization of the RFID hand tactile sensor.

FIG. 9A illustrates a schematic representation of the different layers of the RFID sensing hand, and a separation of the layers and the components to show the inner working of the hand. FIG. 9B illustrates the developed GUI to translate the pressure signals into a visual representation.

FIG. 10A illustrates a schematic diagram of an NFC hand. FIG. 10B illustrates a view of the developed GUI to translate the pressure readings into a visual representation.

FIG. 11 illustrates a schematic diagram view of an implementation where the oscillator is connected to a voltage divider.

FIG. 12 illustrates a schematic diagram view of an implementation where a filter mixed signal sent to a voltage divider.

FIG. 13 illustrates a schematic diagram view of an implementation with an LC oscillator and a voltage divider.

FIG. 14-16 illustrate schematic diagram views of implementation using a flexible grid and any of the oscillation, filter, or LC circuit implementations.

FIG. 17 illustrates graphical views of how two different frequencies can be modulated by a single pressure signal.

FIGS. 18A-18D illustrate a flow diagram for how pressure on a particular taxel in the sensor matric leads to amplitude modulation of two frequencies, and how a FFT can be used to resolve the two frequencies (location of the sensor) and the amplitude (pressure applied on the sensor).

FIG. 19 illustrates a schematic view of a prototype that uses flexible materials for the construction of such a sensor, with one common output where all of the sensor signals are combined.

FIG. 20 illustrates a schematic view of an implementation of the sensor array with PCBs on the perimeter that create different frequency carrier waves that are supplied to the conductive traces on the sensor, showing that by placing the oscillators on the perimeter, only four wires are necessary for arbitrary sized sensor arrays (three for power and one for signal).

FIG. 21 illustrates a schematic view that shows that the piezoelectric material leads to a decaying oscillation, as illustrated in FIG. 13. This decaying oscillation would make the sensor array an event-based sensor, producing oscillating voltages during changes of pressure. However, other embodiments using piezoresistive materials create an event-driven sensor, where a sustained signal is output for the duration of a pressure (not just during the change of the signal). Because the sensor amplitude modulates its associated carrier frequencies, when there is no pressure applied the output signal is very close to zero. Thus the sensor behaves in an event-driven manner (outputting a response proportional to the applied pressure-->so without pressure there is almost no response).

FIG. 22 illustrates a graphical view of a generated STFT plot of frequency versus time versus amplitude in response to sequentially indenting the nine different taxels of the tactile sensor array, illustrated in FIG. 17.

### DETAILED DESCRIPTION OF THE PREFERRED EMBODIMENTS

The presently disclosed subject matter now will be described more fully hereinafter with reference to the accompanying Drawings, in which some, but not all embodiments of the inventions are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated drawings. Therefore, it is to be understood that the presently disclosed subject matter is not to be limited to the specific embodiments disclosed and that modifications and other embodiments are intended to be included within the scope of the appended claims.

A design for large scale, event-based sensing uses a wireless communications protocol. This technology allows for analog sensing of any modality. The technology of the present invention includes modular, wireless sensor. These sensors can be easily mixed and matched over a large area. The present invention can be applied to e-skins, and other applications that require many sensors over a large area. Each sensing ‘pixel’ of the skin is linked to a unique wireless tag, ID number such as a radio frequency identification RFID. All of the sensors can then be read by one wireless reader, and by realizing the ID of a tag, the exact location is determined. Therefore, this translates to an event-based sensor as the reader is constantly listening for a responding tag, but only tags with pressure events respond. The sensors can be wired or wireless. The sensors can also be chipped or chipless depending on the implementation of the invention.

Scalable, high-density e-skins are a highly desirable goal of tactile sensing. However, a realization of this goal has been elusive due to the trade-off between spatial and temporal resolution that current tactile sensors suffer from. Additionally, as tactile sensing grids become large, wiring may be complicated and messy, and therefore, there is a need for a wireless approach. The present invention is directed to a scalable, event-based, passive tactile sensing system is proposed that is based on RFID technology. An exemplary implementation of the present invention, an RFID-based tactile sensing hand, is described further herein. This exemplary implementation is not meant to be considered limiting and is included as an illustration of the system and methodology of the present invention. The RFID-based tactile sensing hand is developed in the shape of a human hand with 19 event-based pressure sensing taxels. The taxels can, in some embodiments, be read wirelessly using a single ‘hand-shaped’ RFID antenna. The RFID tags are transformed into an event-based pressure sensor by disconnecting the RFID chip from its antenna and embedding both into soft elastomer. In the soft elastomer, an air gap is introduced between the RFID chip and its antenna. When a pressure event occurs, the RFID chip contacts its antenna and is able to receive power and communicate with the RFID reader. Future tactile sensing e-skins can utilize this approach to become scalable and dense, while retaining high temporal resolution. Moreover, the approach of tying a sensing pixel to a wireless tag can be applied past tactile pressure sensing, for the development of scalable and high-density sensors of any modality.

To solve the trade-off between spatial and temporal resolution that current tactile sensors suffer from, an event-based approach can be used. The event-based approach eliminates the need for a constant sequential sampling of all of the taxels and instead allows for only the taxels with pressure events to be read. This dramatically increases the temporal resolution and mimics how tactile signals are processed in the human body.

Wireless tactile sensors have become more popular in recent research however none are scalable and event-based. For example, there is a wireless, wide-range pressure sensor based on a graphene/PDMS sponge; but the sensor has no event-based encoding and lacks temporal scalability. Additionally, a CMOS event-driven tactile sensor requires a large off-chip electronic setup to operate the sensor and is not compact.

A new approach to realize a high-density grid of event-based, wireless tactile sensors can be to use wireless communication modalities such as radio frequency identification (RFID) or near-field communication (NFC). RFID tags have unique ID numbers, and because the size of RFID tags have gotten very small in recent years, it is now possible to directly link each unit of a tactile sensing array to an RFID tag. This is beneficial because a grid of RFID tags can be read wirelessly using a single RFID reader antenna, and many tags can be read simultaneously through the use of anti-collision protocols. Alternately, NFC can also be used for this purpose, and can be further customized to do additional functions other than reporting a unique ID number, such as supplying or measuring voltage. Furthermore, some NFC chips have the capability to read multiple voltage levels. This would allow a single NFC chip to report pressure values for multiple tactile sensing units—reducing the total number of chips needed per tactile sensing grid. However, while RFID tags can be purchased commercially, NFC chips may require embedded programming and complicated communication commands.

Due to its high degree of mobility and highly irregular shape, the human hand may be the most complicated region on the body for e-skin design. Therefore, the human hand serves as an excellent region to build a proof-of-concept of a scalable tactile sensing e-skin.

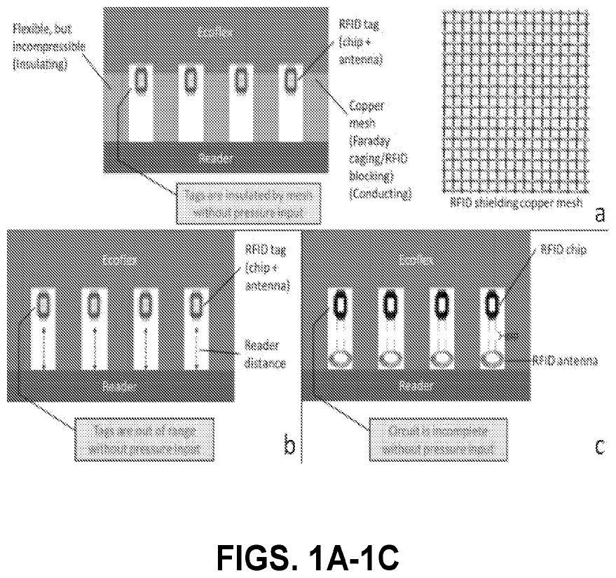

Many different methods of actuation were considered for transforming the RFID tag into an event-based tactile sensor. FIGS. 1A-1C illustrate various actuation methods for transforming an RFID tag into a pressure-based event sensor. These include: a Faraday-shielding approach, a distance-based approach, and a contact-based approach, as illustrated in FIGS. 1A-1C. As illustrated in FIG. 1A, the Faraday shielding approach includes an RFID blocking copper mesh inserted in-plane with the RFID tags. The premise behind the Faraday shielding approach is that the RFID chips are in the range of the RFID reader, but there exists a copper mesh in-plane with the RFID tags that is interfering with the communication. When pressure is applied, the RFID chip will be displaced through the copper mesh, allowing it to communicate with the RFID reader. As illustrated in FIG. 1B, the distance-based approach, includes RFID tags out of range of the RFID reader without pressure input. The premise behind the distance-based approach was that the RFID tags are located slightly out of range of the RFID reader, and when a pressure input is applied, the RFID tag would become within range of the reader. As illustrated in FIG. 1C, the contact-based approach includes RFID chips that are separated from their antennas and only reconnected when a pressure event occurs. The premise behind the contact-based approach is that the RFID chip is disconnected from its antenna and a small air gap is introduced between the two. Once pressure is applied, the RFID chip contacts its antenna, allowing it to receive power and communicate with the RFID reader.

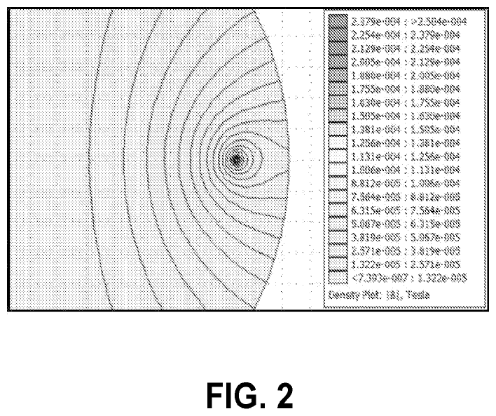

The Faraday shielding approach was not chosen because although somewhat promising in preliminary experiments, it was found to be difficult to build because careful tuning of the copper mesh was necessary in terms of thickness, size, and shape. The distance-based approach was not chosen because after running computer simulations using FEMM, it became apparent that the magnetic field across the grid of RFID tags was not uniform, as shown in FIG. 2, implying that the reading range was also not constant across this grid. FIG. 2 illustrates an FEMM simulation showing an axisymmetrical model of the non-uniform magnetic field generated by a loop of 26AWG copper wire with 2 turns (modelled after a commercial 13.56 MHz RFID reader antenna). This inconsistent reading range makes such an implementation complicated to build. In the end, a contact-based method was chosen for ease of fabrication and overall simplicity.

To reach the full conception of a sensor in the shape of a hand that is based on RFID, there was an evolution from a 1-taxel version, to 2×2 sensing grid, to a full-hand (19 taxels). The 1-taxel version was first created to validate that altering the RFID tag did not affect its communication capabilities. Then the 2×2 grid was created to validate that a contact-based method of actuation was viable and to confirm that embedding RFID chips in Ecoflex™ did not adversely affect its function.

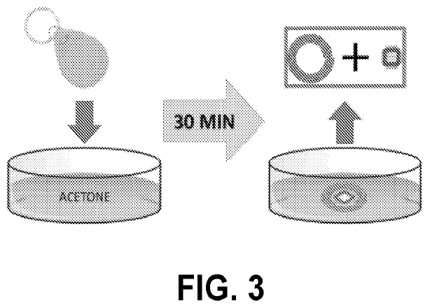

FIG. 3 illustrates a schematic diagram showing the process of removing the RFID chip and RFID antenna from a commercial RFID tag. To fabricate the 1-taxel version, a 125 kHz RFID was dissolved in acetone to recover the RFID chip and its antenna, as illustrated in FIG. 3.

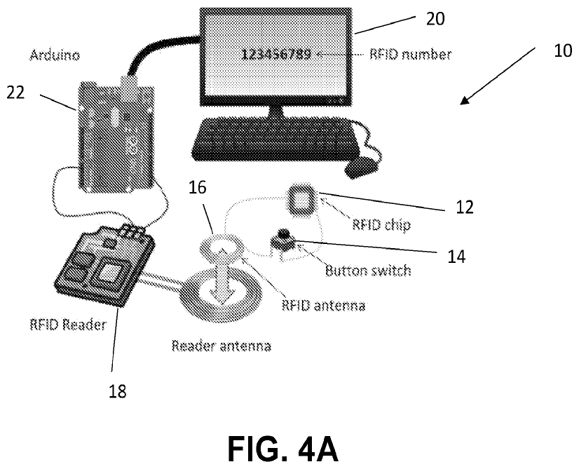

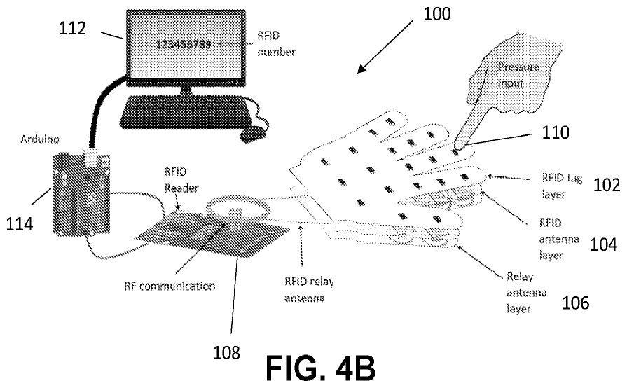

FIGS. 4A and 4B illustrate schematic diagrams showing the setup of the 1-taxel pressure sensor. The system 10 of FIG. 4A includes an RFID chip 12, button switch 14, and an RFID antenna 16. After the RFID was recovered, the RFID chip 12 was disconnected from its antenna 16 and reconnected by soldering it in series with the button switch 14, as illustrated in FIG. 4A. Then, when pressure was applied to the button switch, the circuit was completed, and the RFID chip 12 could be powered by the antenna 16 and begin communicating its ID to an RFID reader 18. The RFID reader is in communication with a computing device 20 via Arduino 22. FIG. 4B also illustrates a schematic diagram of the pressure sensor setup. The system 100 includes a multi-layer sensor setup with an RFID tag layer 102, an RFID antenna layer 104, and a relay antenna layer 106. The antennae communicate with RFID reader 108 when a pressure input 110 is received. The RFID reader 108 is in communication with a computing device 112 via Arduino 114.

In some embodiments, a sensor array can be used. In such an embodiment sensors of various types, such as light sensors and pressure sensors make up the array. For example, a light sensor can be placed in range of the RFID reader, and once its threshold is reached, it will communicate back to the reader its ID and analog light measurement. At the same time, a pressure sensor can be placed adjacent to the light sensor, in the same read range of the RFID reader. Once a sensor/tag threshold is surpassed, it transmits two pieces of information, its ID and its analog measurement value. The RFID reader understands which type of sensor and where that that sensor is located based on its ID, and the RFID reader knows the measurement from the analog value.

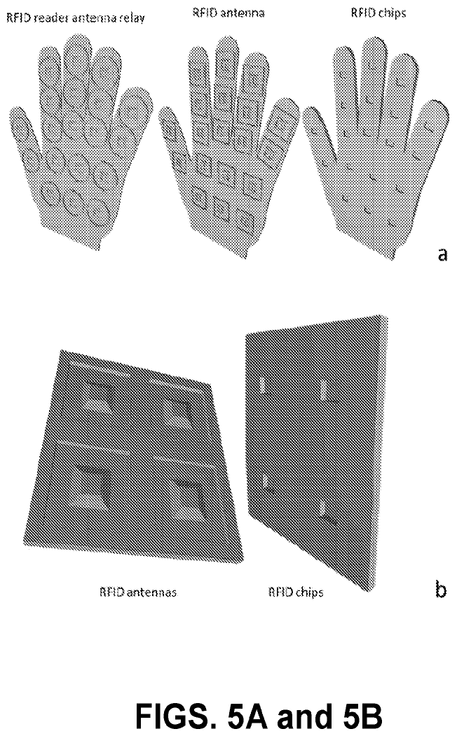

FIGS. 5A and 5B illustrate perspective views of the different Ecoflex™ layers used in the building of the full-hand RFID tactile sensor and the 2×2 RFID tactile sensor. While Ecoflex™ is used here, any suitable material known to or conceivable to one of skill in the art could be used. FIG. 5A illustrates perspective views of three different layers used to build the RFID hand. FIG. 5B illustrates 2 different layers used to build a 2×2 sensor grid. To fabricate the 2×2 sensing grid, a series of silicone molds were first 3D printed using a LulzBot TAZ 5 3D printer. Any suitable manufacturing process known to or conceivable to one of skill in the art could also be used. These molds allowed for two Ecoflex™ layers to be cast: one to support the RFID antennas, and the other to support the RFID chips, as illustrated in FIG. 5B. Like the 1-taxel version, four 125 kHz RFID tags were dissolved in acetone to recover the RFID chips and antennas. The antennas and chips were then placed inside of their respective Ecoflex™ layers and glued in place. The layers were then sandwiched together. For the 1-taxel and 2×2 sensing grids, 125 kHz RFID tags and a 125 kHz RFID reader were used. However, when upgrading to a full-hand sensing skin, a transition was made to 13.56 MHz RFID tags and a 13.56 MHz RFID reader. This was because 125 kHz RFID systems do not have a built-in anti-collision protocol, and therefore only 1 tag can be read at a time. Most 13.56 MHz RFID readers and tags are capable of resolving multiple tags communicating at once. This is essential for the full-hand sensing skin because each taxel is tied to a unique ID. Therefore, if more than one location on the skin becomes activated, it is important to resolve all locations of pressure on the skin. To fabricate the full-hand sensing skin, a process similar to the 2×2 sensing grid fabrication was performed. However, there was one additional mold printed to support a custom RFID reading antenna, as illustrated in FIG. 5A.

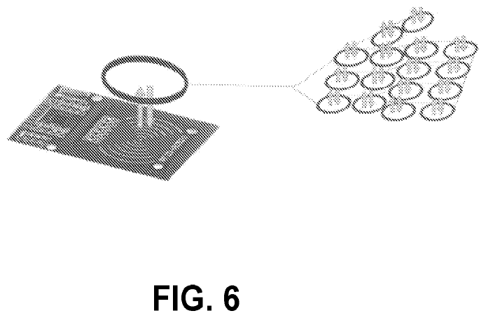

FIG. 6 illustrates a schematic diagram showing the working principle of the RFID relay antenna. The MFRC522 RFID reader is shown on the left and the integrated, on-board antenna can be seen. The relay consists of one large loop of copper wire with 10 turns near the original RFID reader that mimics the current pattern in the RFID reader antenna and relays it to the hand-shaped antenna. The hand-shaped antenna consists of 19 (only 16 shown) small loops of copper wire with 10 turns as well. These 19 small loops were built to be approximately the same size as the RFID tag antennas. Because the human hand is not in a circular or rectangular shape, like most RFID antennas, a custom reading antenna was wound in the shape of a hand to communicate with the RFID tags, as illustrated in FIG. 6. Also, because the RFID reader used was the MFRC522, which included an integrated antenna, a relay system was built to relay the RF communication from the integrated antenna to the hand-shaped antenna, further as illustrated in FIG. 6. Although the full-hand sensing skin represents an event-based, wireless tactile sensor, in its current conception there is no encoding of variable pressure and the hand acts as a binary tactile sensor.

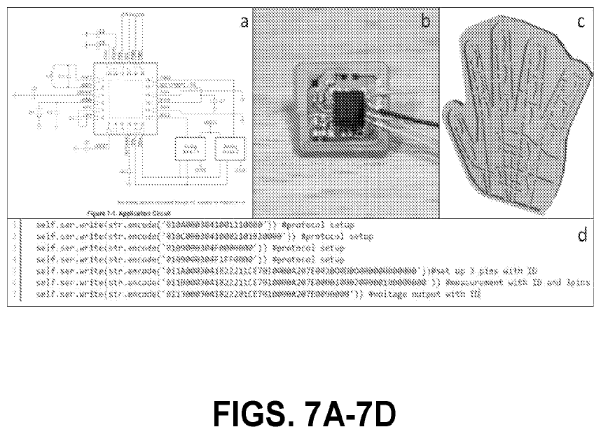

FIGS. 7A-7D illustrate views showing the components of the NFC-based sensing hand. FIG. 7A illustrates a schematic representation of the 20 pin layout of the NFC chip. FIG. 7B illustrates a picture of the NFC chip with 3 ADC pins and ground connected. FIG. 7C illustrates a 3D visualization of the 3D printed mold for casting the Ecoflex™ layer to support 18 piezoresistive taxels and accompanying wiring. FIG. 7D illustrates the different commands sent to the NFC chip to: setup the communication protocol (lines 1-4), set up the 3 ADC pins (line 5), make a voltage measurement (line 6), and output the voltage measurement (line 7). Lines 6 and 7 were repeated in a loop to achieve continuous pressure monitoring.

For many applications, non-binary, variable pressure sensing is desirable. For this reason, an NFC hand was also explored, that was based on reading voltage differentials emanating from contact pressure on a piezoresistive cloth. To build this NFC hand the RF430FRL152H NFC chip was used from Texas Instruments, as illustrated in FIGS. 7A and 7B. To communicate with the NFC chip, the TRF7970 EVM reader was used, also from Texas Instruments. To communicate with the NFC chip, a series of 4 commands were sent to the chip from the reader, as illustrated in FIG. 7D: 1. Setup up the ISO15693 communication protocol; 2. Setup the three ADC pins; 3. Make a voltage measurement using these pins; 4. Report the voltage measurement. Commands 3 and 4 were repeated to achieve continuous pressure monitoring. To fabricate the full-hand NFC variable pressure sensing skin, a silicone mold was also 3D printed, as illustrated in FIG. 7C. This layer supported 18 pieces of piezoresistive fabric and corresponding wiring to supply and read voltage. When pressure is applied to the piezoresistive cloth, its resistance changes, which changes the voltage measurement—allowing for variable pressure measurements.

A relay was not necessary for the NFC based sensing skin because each NFC was capable of reading 3 taxels. Due to this, it was possible to route all of the NFC chips to the bottom of the sensing hand, eliminating the need for a relay.

The main drawback of the NFC-based tactile sensing skin is that in its current inception, there is no event-driven functionality. However, this limitation is not inherent, and with some embedded programming of the NFC chip, it is possible to make this system event-based as well. However, with the resources available during the time of this project, such embedded programming was not feasible. To characterize the RFID-based tactile sensing hand the minimum force to response was measured, as well as the response time of the RFID tags. An attempt to characterize the NFC-based tactile sensing hand was also made; however, in initial experiments the NFC chip gave a highly variable response and further work must be performed to make it more robust.

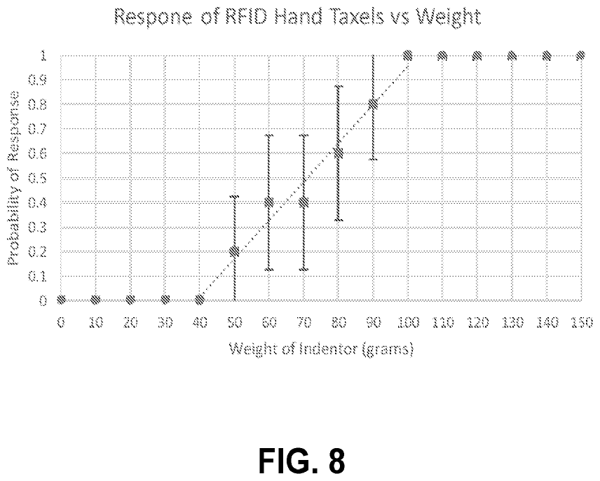

FIG. 8 illustrates a graphical view of a characterization of the RFID hand tactile sensor. The response of the RFID-based taxels were measured in response to different indentor weights. Extrapolating the line of best fit shows that a probability of 0.5 is achieved at a weight of 70 grams. Therefore, 70 grams represents the threshold of the RFID hand tactile sensor. All 19 taxels of the RFID hand developed were functional validating the proof-of-concept. Moreover, a basic characterization of the taxels was obtained to understand the minimum pressure necessary to activate a taxel, as illustrated in FIG. 8.

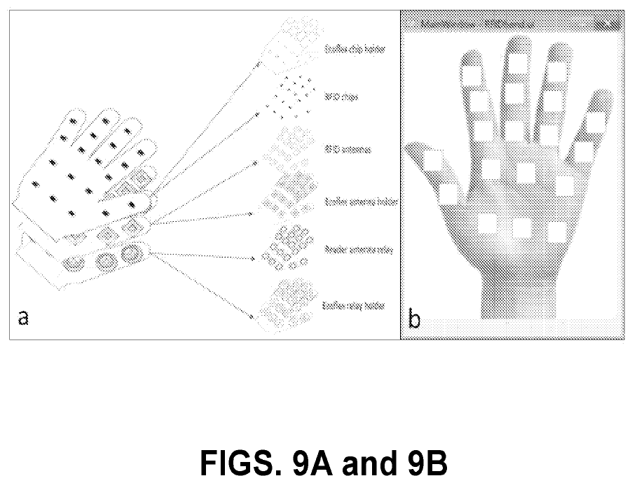

FIG. 9A illustrates a schematic representation of the different layers of the RFID sensing hand, and a separation of the layers and the components to show the inner working of the hand. FIG. 9B illustrates the developed GUI to translate the pressure signals into a visual representation. The 19 squares in the GUI map directly to the 19 corresponding taxels of the RFID hand.

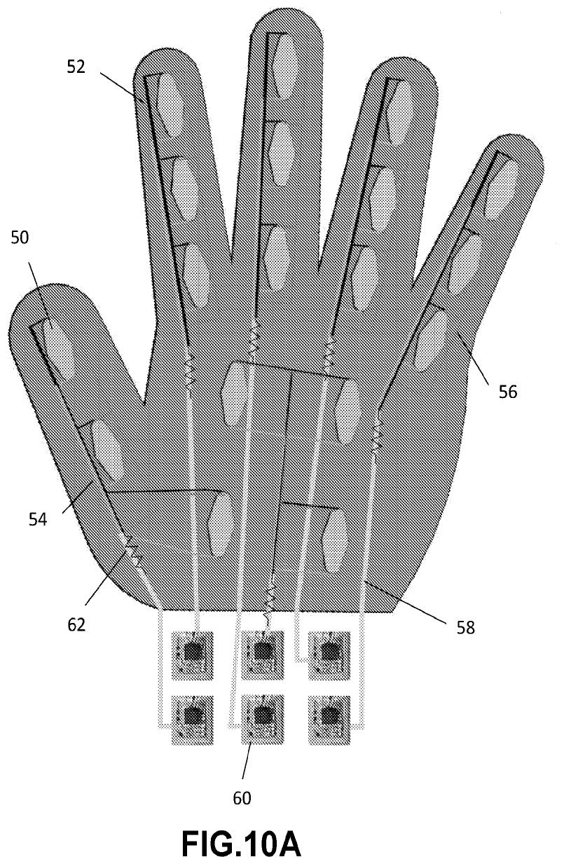

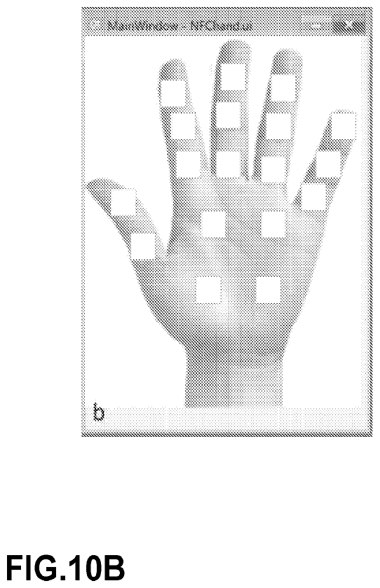

FIG. 10A illustrates a schematic diagram of an NFC hand. The diamond shapes 50 represents pieces of piezoresistive cloth, lines 52 represents voltage supply, lines 54 represent voltage ground, lines 56 represent voltage reference, and lines 58 represent the grouping of all traces for each near field communication (NFC) chip and shows their direct wiring to the NFC chips 60. Resistors 62 are also included. Each of the resistors 62 is in series with the three sensors effectively forming three voltage dividers. FIG. 10B illustrates a view of the developed graphical user interface (GUI) to translate the pressure readings into a visual representation. The 18 squares on the GUI directly map to the 18 corresponding taxels in the NFC hand. A schematic of the function of the NFC hand is shown for obtaining variable pressure, as illustrated in FIG. 10A. A GUI was also developed to visualize the NFC hand pressure values, as illustrated in FIG. 10B. However, characterization is not reported because the NFC chips gave highly variable results, and further work must be done to improve robustness. This potentially includes changing the piezoresistive fabric design and replacing the manual wiring with conductive traces.

In this work, a proof-of-concept is demonstrated for how to build flexible, event-based, wireless tactile sensors using RFID or other wireless communication methods known to or conceivable to one of skill in the art, such as NFC. This approach is more scalable than non-event-based and non-wireless methods and is be useful in the development of large-scale e-skins. The primary application lies in prosthetics; however, other applications such as smart robotics are also attractive. Moreover, although this work focuses on tactile sensing, the approach of using a high-density grid of event-based RFIDs can be applied for any type of sensing such as temperature, light, sound, or voltage. The essential concept of the work is that each unit of the sensing grid is tied to a unique ID, and that all of the units of the sensing grid are read by one reader, wirelessly, in an event-based manner. Additionally, this approach can be applied to any sensing modality.

Building a high-density, event-based, wireless, sensing system for any type of sensor can be achieved if an application-specific integrated circuit (ASIC) chip is designed to replace the RFID tags. In this case, the generic sensing platform can work as follows: (1) The ASIC chip reader provides power to the grid of ASIC chips through inductive coupling, (2) ASIC chip with integrated sensor makes a measurement, (3) Once a certain voltage threshold is met during the measurement, the ASIC chip communicates back to its reader. This general scheme allows for scalable and wireless, event-based sensing in any paradigm—limited only by the type of sensors that can be incorporated into the ASIC chip.

In another embodiment according to the present invention, the device can take the form of chipless sensors. Chipless RFID sensors encode their unique identification number as their communication frequency. Through either frequency modulation (FM) or amplitude modulation (AM) signals, an analog signal can be transmitted by the device at a particular frequency. Tactile data is encoded through these AM/FM signals. Such chipless RFID sensors can be made to be highly flexible with a very small footprint. These sensors can also be used to develop new e-skins with high spatial and temporal resolution. To meet the goal to have each taxel communicate at separate frequencies, and on the receiving end decode which taxels are responding, there are several possible approaches. These approaches include, but are not limited to connecting the oscillator to a voltage divider, sending a mixed signal and having each taxel filter particular frequencies using a bandpass filter and then applying a voltage divider, or having an LC circuit (resonant circuit, tank circuit, or tuned circuit), where L represents an inductor and C represents a capacitor, in each taxel and modulate the voltage with a voltage divider.

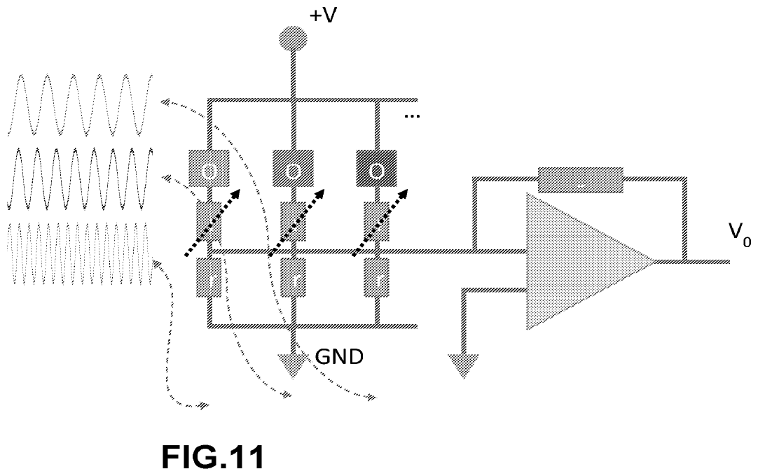

FIG. 11 illustrates a schematic diagram view of an implementation where the oscillator is connected to a voltage divider. In the implementation illustrated in FIG. 11, oscillators on each taxel produce sine wave of varying frequencies. The voltage divider circuit amplitude-modulates the carrier signal and an op-amp summer combines signals together. A fast Fourier transform (FFT) is used to find out which frequencies are responding. The amplitude of the signal is measured to get the analog measurement.

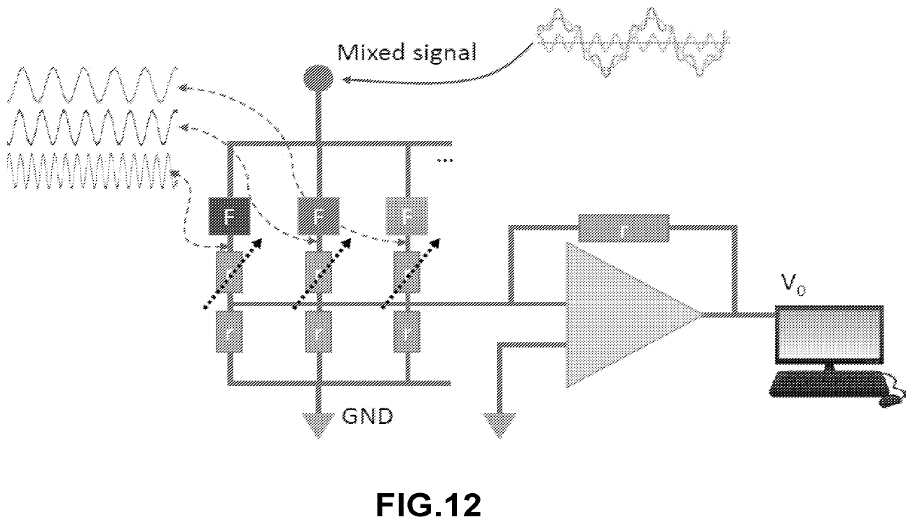

FIG. 12 illustrates a schematic diagram view of an implementation where a filtered mixed signal is sent to a voltage divider. In the implementation illustrated in FIG. 12, a bandpass (BP) filter allows specific frequencies to each taxel. A voltage divider circuit amplitude-modulates the carrier signal, and an op-amp summer combines signals together. An FFT is used to find out which frequencies are responding. The amplitude of the signal is measured to get the analog measurement.

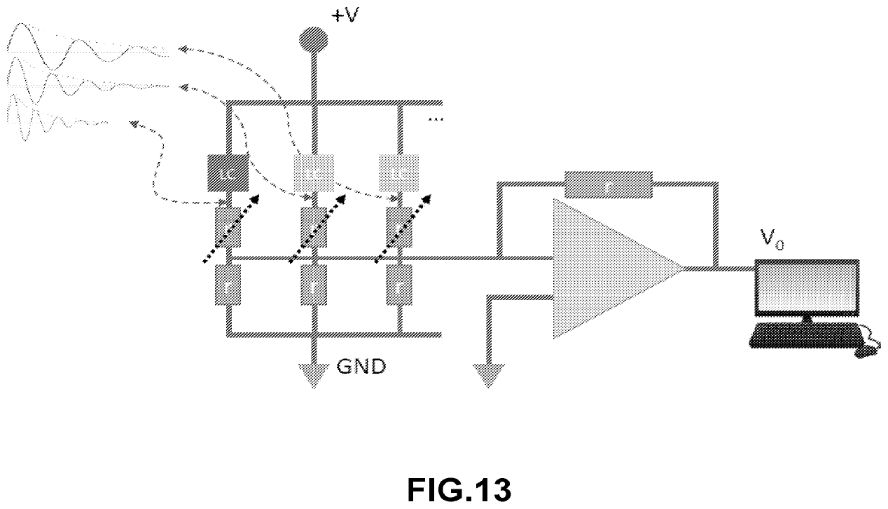

FIG. 13 illustrates a schematic diagram view of an implementation with an LC oscillator and a voltage divider. As illustrated in FIG. 13, changing voltage at each taxel leads to damped oscillations at a particular frequency. A voltage divider circuit pulses the oscillations, and an op-amp summer combines signals together. An FFT is used to find out which frequencies are responding. The amplitude of the pulse is measured to get the change in measurement.

In an AM signal implementation, an LC circuit sets the frequency of transmission. An electret microphone modulates current through a transistor. By modulating current through the transistor, the impulse response is pulsed.

For an RF transmitting piezoresistive sensor, the device includes a variable resistor. Each taxel has its own resonant frequency (f) set by LC values. The RF band is very wide (3 kHz-300 GHz) allowing for many transmitters to simultaneously transmit without interference. The transistor is in its cutoff state when V_{be}˜<0.4V, which is the threshold for event-based communication.

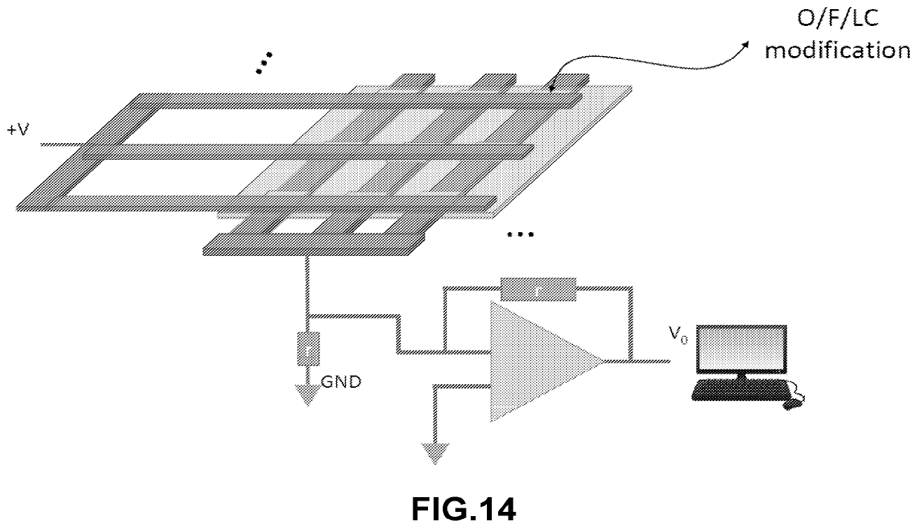

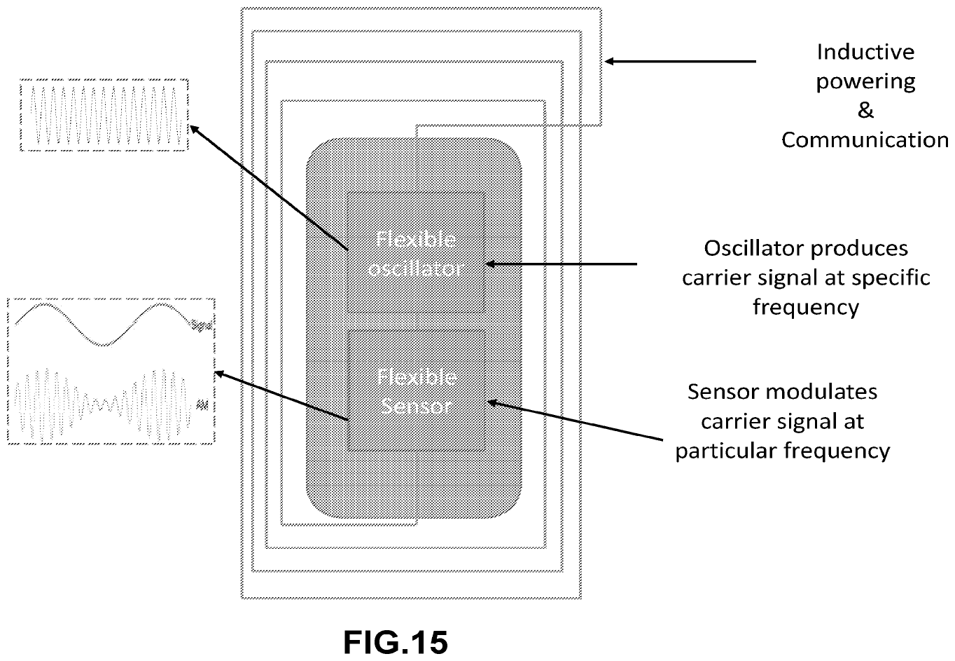

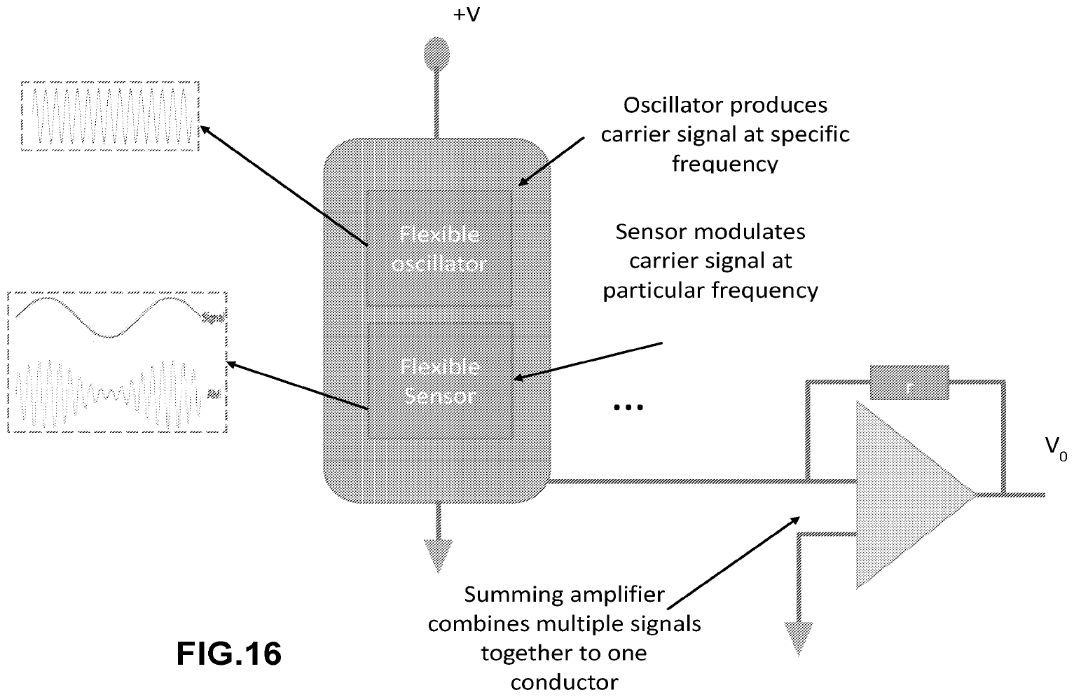

FIG. 14-16 illustrate schematic diagram views of implementation using a flexible grid and any of the oscillation, filter, or LC circuit implementations. The implementation of FIGS. 14-16 include a flexible grid for sensing input. That input is then processed using one of the processes described above. This design results in a flexible material for sensing.

Other embodiments use tuple frequency encoding, where instead of each sensor communicating at one frequency, each sensor communicates as a combination of two (like x and y coordinates). The advantage of this technique is that it greatly reduces the total number of required oscillators from m*n to m+n (where m is the number of rows and n is the number of columns in the sensor array). Additionally, the other major advantage of this tuple encoding scheme is that it does not require any integrated electronics inside each tactile sensing unit. This allows for the sensor array to become extremely dense because there are no required electronics/chips for each taxel.

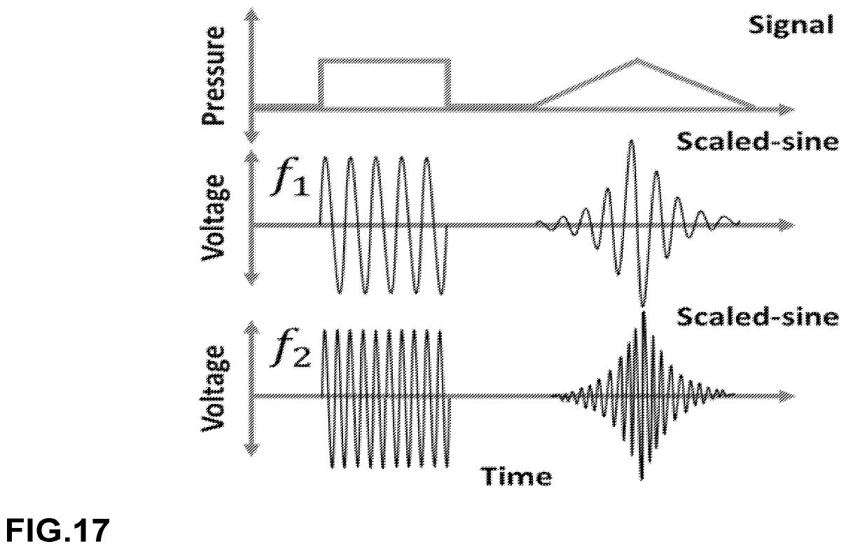

FIG. 17 illustrates graphical views of how two different frequencies can be modulated by a single pressure signal. To implement this encoding method, each element of the sensor array is designed to modulate a different frequency carrier wave, as illustrated in FIG. 17. Coordinate-based encoding is used to simplify fabrication and allow for a denser sensor array with fewer wires. Thus, each taxel modulates a tuple of frequencies to encode spatial location (frequency x, frequency y). Using a tuple of frequencies necessitates an m+n number of oscillators rather than m*n for non-coordinate-based encoding. FIG. 17 illustrates spatial frequency encoding of two sensors (with different frequencies f1 and f2). The applied pressure modulates the carrier wave of each sensor producing an amplitude modulated signal at a specific frequency.

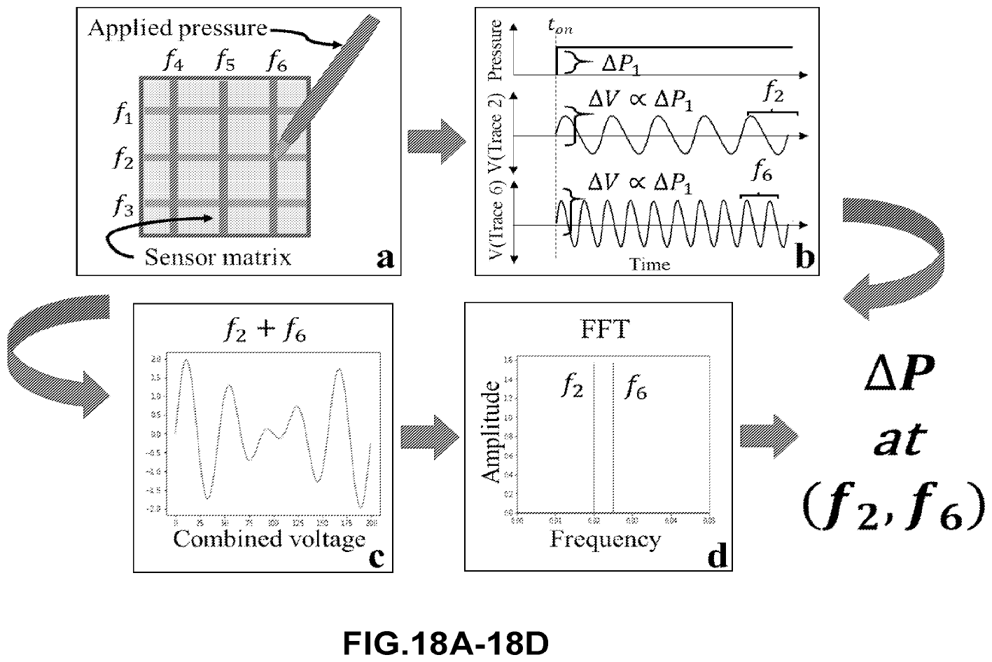

FIGS. 18A-18D illustrate a flow diagram for how pressure on a particular taxel in the sensor matric leads to amplitude modulation of two frequencies, and how a FFT can be used to resolve the two frequencies (location of the sensor) and the amplitude (pressure applied on the sensor). Spectral analysis is used to resolve which frequencies are present in the measured signal and with what amplitude they are present. A Fourier transform is used to convert the signal from the time domain into the frequency domain. The peaks present in the transformed signal are then analyzed to resolve the amplitudes of the different frequency signals. The general encoding and decoding scheme for a coordinate-based spatial frequency encoded tactile sensing matrix is shown in FIGS. 18A-18D. As different spatial locations in the sensor matrix are activated, different frequency sinusoids are amplitude modulated and summed into a combined voltage. The spectrum of this combined voltage is then analyzed to resolve the frequencies, and their corresponding amplitudes, to determine the pressure signal applied on the sensor array. FIG. 18A illustrates applied pressure to taxel (f₂, f₆). FIG. 18B illustrates the different frequency voltage responses to be summed on the single conductor. FIG. 18C illustrates the combined voltage, and FIG. 18D illustrates the resolved frequencies in the FFT.

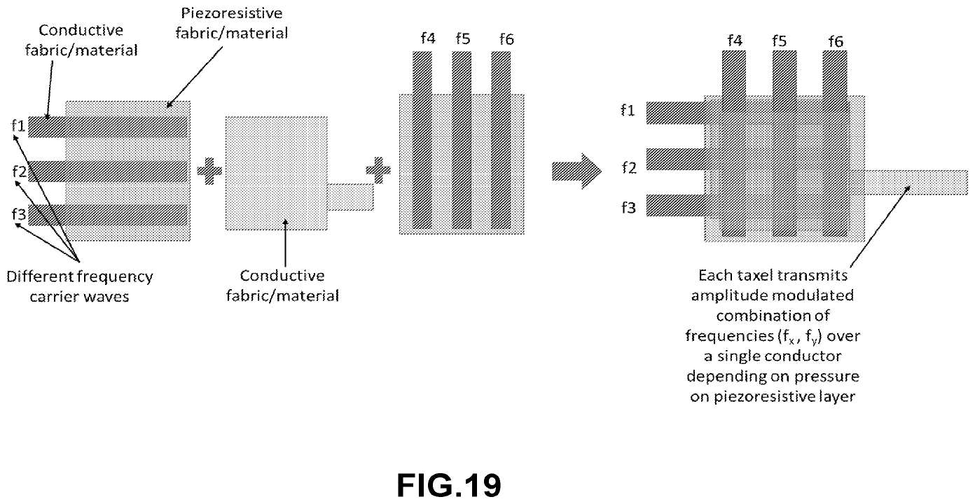

FIG. 19 illustrates a schematic view of a prototype that uses flexible materials for the construction of such a sensor, with one common output where all of the sensor signals are combined. The tactile sensor array was fabricated using e-textile materials to be flexible and conformable. To achieve spatial frequency encoding the typical fabrication structure was slightly altered by introducing a large piece of conductive fabric to transmit the different frequency signals on a single common wire. An overview of the prototype fabrication is illustrated in FIG. 19. Light grey represents a piezoresistive fabric, such as a silver plated mesh. Darker grey illustrates a conductive fabric Transparency in the colors represents overlapped elements with darker elements appearing on top of lighter ones.

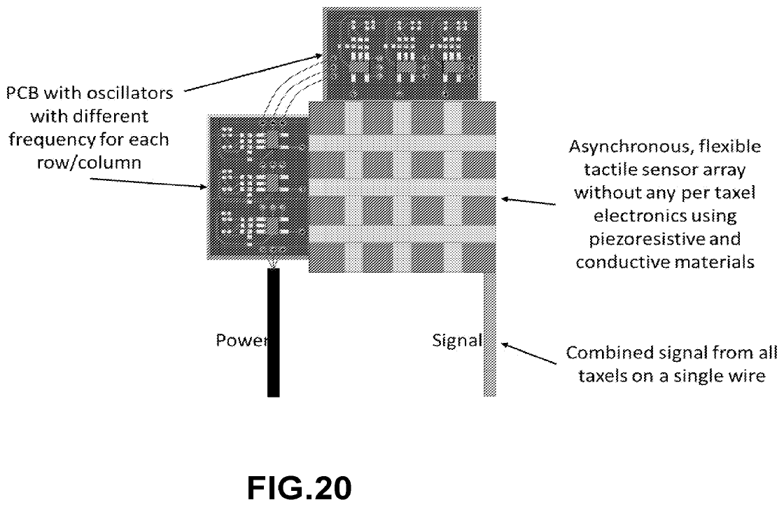

FIG. 20 illustrates a schematic view of an implementation of the sensor array with PCBs on the perimeter. The PCBs create different frequency carrier waves that are supplied to the conductive traces on the sensor. This shows that by placing the oscillators on the perimeter, only four wires are necessary for arbitrary sized sensor arrays (three for power and one for signal).

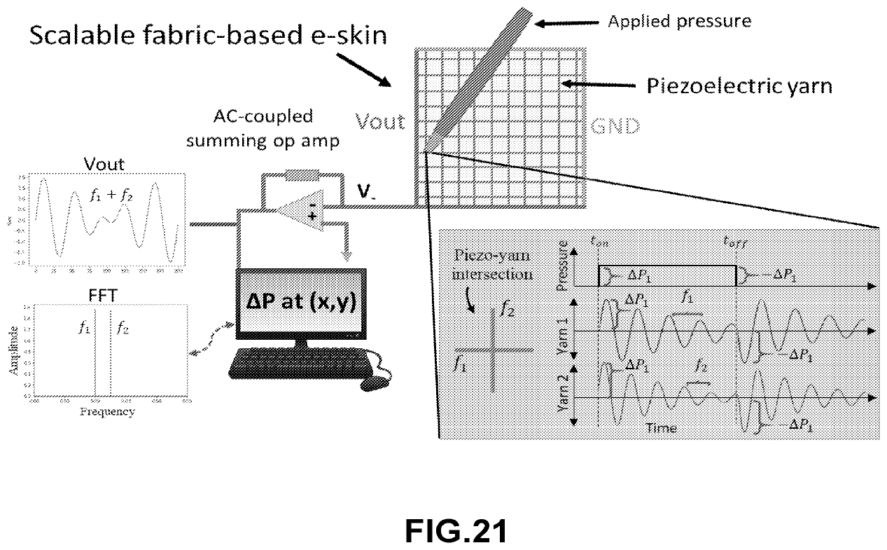

FIG. 21 illustrates a schematic view that shows that the piezoelectric material leads to a decaying oscillation, as illustrated in FIG. 13. This decaying oscillation would make the sensor array an event-based sensor, producing oscillating voltages during changes of pressure. However, other embodiments using piezoresistive materials create an event-driven sensor, where a sustained signal is output for the duration of a pressure (not just during the change of the signal). Because the sensor amplitude modulates its associated carrier frequencies, when there is no pressure applied the output signal is very close to zero. Thus the sensor behaves in an event-driven manner (outputting a response proportional to the applied pressure-->so without pressure there is almost no response).

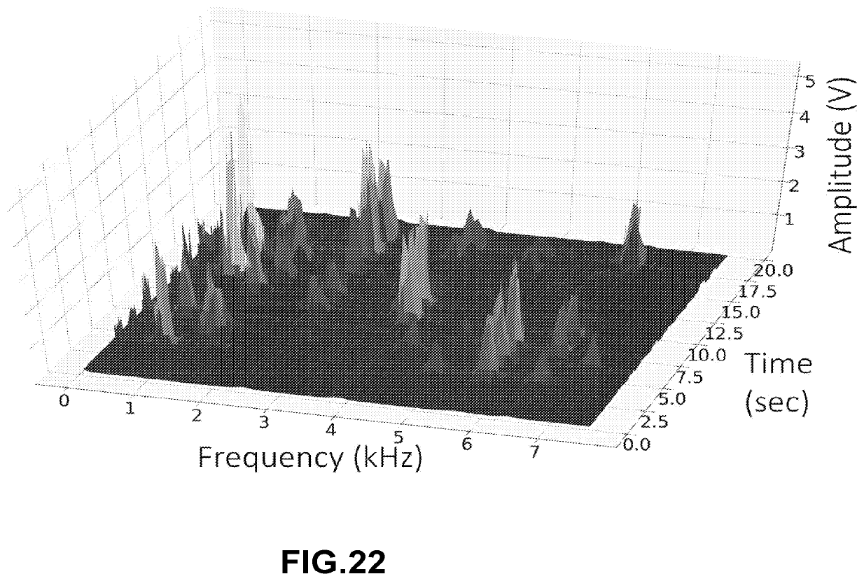

FIG. 22 illustrates a graphical view of a generated STFT plot of frequency versus time versus amplitude in response to sequentially indenting the nine different taxels of the tactile sensor array, illustrated in FIG. 17. The use of the spatial frequency encoded sensor in a texture discrimination task is demonstrated. Thus, the short-time Fourier transform (STFT) is calculated in windows of length 1500 samples. This number was picked empirically by trying different window values and measuring the relative power of the spectrum. An example STFT plot for the sensor fabricated in FIG. 17 is shown in FIG. 22. This plot represents an STFT calculated after sequentially indenting the nine different taxels of the tactile sensor array. Notably, the plot shows how an indentation of each taxel results in two dominant frequencies in the STFT. This combination of frequencies is used to resolve the location of the applied pressure. To convert the spectral data into different taxel values, the following algorithm was used. In the algorithm, ‘amp’ refers to the amplitude of the frequencies (f₁, . . . , f₆) measured by the STFT.

$$Taxel 1 = amp ( {f}_{1} ) \times amp ( {f}_{4} )$$

$$Taxel 2 = amp ( {f}_{1} ) \times amp ( {f}_{5} )$$

$$…$$

$$Taxel 9 = amp ( {f}_{3} ) \times amp ( {f}_{6} )$$

Following this algorithm, nine taxel values were calculated for each window in the STFT based on the amplitudes of the six carrier frequencies present in that time window. These taxel values were the metrics used to perform the texture discrimination task.

It should be noted that the communications protocols described herein can be executed with a program(s) fixed on one or more non-transitory computer readable medium. The non-transitory computer readable medium can be loaded onto a computing device, server, imaging device processor, smartphone, tablet, phablet, or any other suitable device known to or conceivable by one of skill in the art.

It should also be noted that herein the steps of the method described can be carried out using a computer, non-transitory computer readable medium, or alternately a computing device, microprocessor, or other computer type device independent of or incorporated with the present invention. An independent computing device can be networked together with the device either with wires or wirelessly. Indeed, any suitable method of analysis known to or conceivable by one of skill in the art could be used. It should also be noted that while specific equations are detailed herein, variations on these equations can also be derived, and this application includes any such equation known to or conceivable by one of skill in the art.

A non-transitory computer readable medium is understood to mean any article of manufacture that can be read by a computer. Such non-transitory computer readable media includes, but is not limited to, magnetic media, such as a floppy disk, flexible disk, hard disk, reel-to-reel tape, cartridge tape, cassette tape or cards, optical media such as CD-ROM, writable compact disc, magneto-optical media in disc, tape or card form, and paper media, such as punched cards and paper tape.

Although the present invention has been described in connection with preferred embodiments thereof, it will be appreciated by those skilled in the art that additions, deletions, modifications, and substitutions not specifically described may be made without departing from the spirit and scope of the invention as defined in the appended claims.

1. A device comprising:
a modular, wireless sensor, wherein the modular, wireless sensor has an identification tag, and wherein the modular, wireless sensor is further configured to transmit the identification tag in response to a sensor event; and
a wireless reader for receiving input from the modular, wireless sensor, wherein the wireless reader identifies the modular, wireless sensor experiencing the sensor event using the identification tag.

2. The device of claim 1 wherein the modular, wireless sensor comprises a radio frequency identification (RFID) sensor.

3. The device of claim 1 wherein the modular, wireless sensor comprises a near field communication (NFC) sensor.

4. The device of claim 1 wherein the sensor event takes the form of pressure applied to the modular, wireless sensor.

5. The device of claim 2 wherein the RFID sensor comprises an RFID chip and an RFID antenna.

6. The device of claim 5 wherein the RFID chip and the RFID antenna are separated such that a pressure event is needed to reconnect the RFID chip to the RIFD antenna to allow the RIFD sensor to transmit the identification tag.

7. The device of claim 1 wherein the modular, wireless sensor comprises a sensor array.

8. The device of claim 7 wherein the sensor array comprises different types of sensors.

9. The device of claim 1 wherein the modular, wireless sensor further comprises an application-specific integrated circuit (ASIC) chip.

10. The device of claim 1 wherein the wireless reader comprises an ASIC chip reader.

11. The device of claim 10 wherein the ASIC chip reader provides power to the ASIC chip through inductive coupling.

12. The device of claim 1 wherein the modular, wireless sensor is configured to use tuple frequency encoding, such that the modular, wireless sensor communicates a combination of two or more frequencies; and does not require the integration of oscillators, microcontrollers, or other electronics into each sensing pixel.

13. A device comprising:
a modular, wireless sensor, wherein the modular, wireless sensor is configured to use tuple frequency encoding, such that the modular, wireless sensor communicates a combination of two or more frequencies; and
a wireless reader for receiving input from the modular wireless sensor, wherein the wireless reader identifies the frequencies transmitted by the modular, wireless sensor.

14. The device of claim 13 wherein the modular, wireless sensor comprises a radio frequency identification (RFID) sensor.

15. The device of claim 13 wherein the modular, wireless sensor comprises a near field communication (NFC) sensor.

16. The device of claim 13 wherein the sensor event takes the form of pressure applied to the modular, wireless sensor.

17. The device of claim 14 wherein the RFID sensor comprises an RFID chip and an RFID antenna.

18. The device of claim 13 wherein the modular, wireless sensor comprises a sensor array.

19. The device of claim 18 wherein the sensor array comprises different types of sensors.

20. The device of claim 13 wherein the modular, wireless sensor further comprises an application-specific integrated circuit (ASIC) chip.
